(19) United States
(12) Patent Application Publication
(10) Pub. No.: US 2026/0030676 A1
(43) Pub. Date: Jan. 29, 2026

(54) Money convertible to agricultural products and its monetary system

(71) Applicant: Motonari TAKEYAMA, Tokyo (JP)

(72) Inventor: Motonari TAKEYAMA, Tokyo (JP)

(21) Appl. No.: 18/994,634

(22) PCT Filed: Jul. 31, 2022
(86) PCT No.: PCT/JP2022/029411

§ 371 Date: Jan. 15, 2025

(51) Int. Cl. G06Q 40/04; G06Q 40/06; G06Q 50/02

(52) U.S. Cl. CPC G06Q 40/046; G06Q 40/055; G06Q 40/063; G06Q 50/02

(57) ABSTRACT

This invention is a money convertible to agricultural products and a system to construct it. The agricultural products are stored in a storage facility, and their quantity and quality are controlled using a computer. Based on the storage data of the agricultural products, the money is issued and circulated. The amount of the agricultural products in storage always matches the amount of the money issued, which is controlled by computer. Transactions of the money or the conversion of the money to the agricultural products are matched by the computer and network. In addition, provide a system in which the quality of agricultural products deteriorates and depreciates over time, which is reflected in the money convertible to agricultural products, and in which the money depreciates, and/or in which the money has a time limit on its use.

### TECHNICAL FIELD

The present invention relates to electronic money and tokens and systems thereof. And it relates to storage facilities for agricultural products.

### BACKGROUND ART

In 1730, the Edo shogunate under the 8th shogun, Tokugawa Yoshimune, officially authorized the Dojima Rice Exchange (original name: Dojima Kome-Kaisho) in Dojima, Osaka, Japan, to conduct physical rice trading and futures rice trading. The chouaimai-trading (ledger rice trading) here was the first futures market in the world. In explaining the purpose and effect of the present invention, the trading mechanism at the Dojima Rice Market is greatly related to the background of the present invention, so here is a brief introduction.

In Japan, an agricultural society based on rice cultivation was almost completed in the 3rd century AD, when Himiko was the queen of the Yamataikoku Kingdom, and a society centered on rice was established. The community called yui, that emerged from the communal labor of rice cultivation and water management became the foundation of Japanese society. Those who owned rice had wealth and power, and in the Edo period (1603-1867), the rice harvest became a rating for the clans that ruled each region, and was often the cause of disputes over rice-growing territories. The size of a feudal lord's domain, which controlled the rice fields subject to tax collection from rice, was expressed in terms of the amount of koku-daka (stipend). One koku is about 180 liters (about 150 kg), or the amount of rice one person eats in a year. Each clan transported the rice collected in their respective territories to Edo (present-day Tokyo) and Osaka, and due to the need to convert large amounts of shogunate rice and clan rice into cash, they cashed it in to purchase necessary supplies. Rice was a major grain and the basis of life and economy. Against this backdrop, the Dojima Rice Exchange was established to conduct rice transactions, and the rice market prices determined at the exchange became the foundation of the Japanese economy.

In the vicinity of the Dojima Rice Exchange, there were combined warehouses and residences, called kurayashiki, where rice brought in by feudal lords from all over Japan from their territories was stored. The rice stored in these warehouses was called kuramai, and in exchange for it, certificates of deposit similar to warehouse bills, called kuramai-kitte, were issued and traded at the Dojima Rice Exchange. The kuramai-kitte was a convertible note for kuramai, usually it could be converted into 10 koku of rice per sheet. The kuramai-kitte were originally issued backed by stocks of kuramai, but often, for the purpose of raising funds for the feudal lords, kuramai-kitte were issued as karamai-kitte, which were not backed by kuramai. However, in any of the kuramai-kitte, the right to claim the kuramai was protected by a system under which they could be exchanged for a certain amount of kuramai at any time, and the Edo shogunate would purchase them in the unlikely event that they were ever dishonored. The holder of a kuramai-kitte shall receive the kuramai at any time before the deadline, which is called “oidashi” or “kurabarai”, set by the kurayasiki that issued the kuramai-kitte, so the circulation period of kuramae-kitte was the period from the date of issue to the date of oidashi. As such, kuramai-kitte were used for settlement as certificates that allowed physical exchange for the rice described on the face of the certificate.

Some kuramai-kitte had an expiration date of more than one year from the date of issue. However, in Japan, new rice arrives every year, so the rice can be shipped not only from the year of issue of the kuramai-kitte, but also from the following year. Therefore, it can be inferred that in reality, the storage period of kuramai was one year or less. However, the kurayashiki was responsible for any loss or damage of the stored rice during the storage period, so the storage of the rice was an important matter. When storing rice for a long periods of time, dried mugwort, peach leaves, and mulberry leaves were placed inside the rice bales, or mixed with straw ashes from early rice plants, in order to prevent the quality of the rice from changing.

As convertible note for rice stored in kurayashiki, kuramai-kitte could be used not only in exchange for rice, but also as a means of raising cash, and was circulated in the market for use in capital savings and as payment for goods. This means that the kuramai-kitte had the function of money.

In addition to physical rice trading using kuramai-kitte, the Dojima Rice Exchange also conducted futures trading called “chouaimai-trading”, in which rice of an index grade was traded only on the account books, and settled for a difference in the future through countertrading. This was invented as a mechanism to avoid losses from fluctuations in the physical market through futures trading, since it was possible to hedge risk by combining chouaimai-trading with physical trading. Futures trading at the Dojima Rice Exchange also allowed for clearing by physical delivery using kuramai-kitte if there was a gap between the cash price and the futures price on the maturity date of the transaction, thus eliminating the spread between the cash and the futures through arbitrage trading. Generally, futures transactions are assumed to be settled by the spot price on the maturity date, and the brokerage house compares the futures price with the spot price and sells the overvalued one and buys the undervalued one to earn arbitrage profit, so that both price differences converge and the futures price matches the spot price on the maturity date. This arbitrage transaction extends not only to the spread between the futures and spot prices at the Dojima Rice Exchange, but also to the spread with the Otsu Imperial Rice Exchange (original name: Otsu Goyo Komekaisho, located in present-day Otsu City, Shiga Prefecture, Japan), another exchange that was officially licensed at the same time. A letter carrier, called a “hikyaku,” transmitted the information by man and horse. This is the present-day postal service. In particular, in the area around the Dojima Rice Exchange, there were “kome-hikyaku” who specialized in communicating trends in the rice market to the local regions. In addition, along with the letter carriers, flag-waving communication existed as a means of communicating market price information. It is a means of communication similar to hand signals, in which a flag winger is placed every few kilometers to a dozen kilometers to transmit information one after another according to a pre-determined signal chart. In order to prevent information theft, this communication intentionally included erroneous information and encryption was used. The transmission of such information was important in order to obtain market price information earlier than others and thereby gain an advantage in arbitrage trading of rice prices in the market.

On the other hand, in the modern era, technology has been established to store rice for long periods of time by controlling humidity and temperature, and by using country elevators and low-temperature warehouses to prevent quality deterioration and maintain a certain level of quality. Such storage methods are applied not only to rice but also to grains in general, and agricultural products other than grains can be stored by drying or freezing.

In addition, a network environment using computers and the Internet enables various types of transactions to be conducted at high speed and in large volumes. The communication network also allows market information to be instantly transmitted to various regions, and computer-programmed automated trading systems are used to arbitrage among commodities, markets, or contract months.

The next section refers to money and currency.

Currency is the money that is guaranteed in value by the state, given compulsory acceptability by law, and put into circulation. Originally, money should be a standard currency convertible into a valuable object of absolute value such as gold or silver, but the expansion of the money market has made it difficult to convert it into a standard currency or a valuable object. The face value of the current currency is guaranteed by the state or economic community that issues it. Crypto assets such as Bitcoin and Ethereum are virtual currencies, and governments differ on whether or not they qualify as currency.

In relation to money, there are opportunities to use tokens in the economy and society. The interpretation of the term token is defined differently depending on the environment and context in which it is used. Tokens are generally substitute money, issued by governments as coins and used as a substitute for legal currency. And, the use of tokens issued by the private sector, for example, if the fare for a bus or train ride is replaced with a single token in advance, and the passenger pays with the token when boarding the bus or train, there is no need to prepare multiple coins, thus increasing convenience. In addition, there are DeFi (Decentralized Finance) tokens, which run on the blockchain using smart contracts to execute transactions in financial systems, such as banks and exchanges, through decentralized applications. There are also Non-Fungible Tokens (NFT), which trade ownership of original virtual or real space assets, and Security Tokens, which are legal securities digitized and issued using blockchain technology.

In addition, e-money and prepaid cards provide payment convenience and consumer retention through reductions that award points based on consumption or by means of recharging currency or points to be used for payment. Such technological means that enable electronic payment in place of money include the QR code (registered trademark) payment system developed by Denso Corporation (Japan) and the FeliCa (registered trademark) contactless IC card developed by Sony Corporation (Japan).

The above provided the historical background of how certificates that promised to be converted to rice, an agricultural product, were traded, circulated, and used as payment like money. It is also shown that grain could be stored for a certain period of time while maintaining a certain quality. It is also a historical fact that information in one market influences price formation in another market, and that the information transmission network plays an important role. Furthermore, in the area of money and currency, the emergence of electronic money or currency, in addition to the previous definitions, has made it technically possible to construct a new monetary system.

The terms used in the description of the invention have the following meanings respectively, but the scope of the invention shall not be limited by their expression or interpretation.

Money and Currency: Money constitutes the functions and elements that provide the measure of value of commodities, the medium of commodity circulation, and the means of payment for the exchange of commodities. Currency has the primary role of circulation and means of payment, and money encompasses currencies. A money or currency that by law has mandatory acceptability as a means of payment or circulation is called a legal money or legal currency. However, due to the monetary system that does not presuppose the convertibility of the standard currency, money and currency are now treated synonymously. For the purposes of this description, currency is defined as money that is in public circulation, and even if it is not in public circulation, it is defined as money that satisfies the functions and elements of such money. In addition, crypto assets and tokens that fulfill the same shall be interpreted as money.

Crypto assets: Electronic currencies, also called virtual currencies, such as Bitcoin, Ethereum, etc. In addition, crypto assets composed by blockchain, which is an elemental technology of these crypto assets, are called tokens.

Tokens: Similar to coins issued by governments, but primarily issued by private companies, organizations, or individuals and circulated as a substitute for money. In the field of digital currency and crypto assets, tokens are synonymous with crypto assets built on the blockchain. However, some definitions of the term token may not include crypto assets with their own blockchain, such as Bitcoin or Ethereum.

Conversion: The general meaning is to exchange banknotes or government bills for base money or gold bullion, etc. Broadly speaking, to replace or exchange, but in the present invention it means to exchange for something of economic value.

Depreciation of money: Depreciation of money due to a decrease in the amount of valuable objects that can be converted into one unit of money, or due to a decrease in the amount of money held by the holder of the money. For the latter, it is a decrease in the real value of the money from the time it was acquired, as the money that was there at the time of acquisition diminishes over time. For both of these, in the present invention, it means the depreciation of money.

Conforming quality: conformity with the quality standards required for the purpose; in the present invention, for the purpose of converting money into agricultural products, the quality of the agricultural products, such as freshness and standard, is conforming to the appropriate standards.

Agricultural products with preservability: Agricultural products include grains, vegetables, fruits, etc., as well as livestock products. For the purpose of this invention, agricultural products that can be preserved for a relatively long period of time and maintain their commercial value are the target. Agricultural products can be preserved by drying, freezing, or other means to maintain their quality, but the most commonly preserved agricultural products are grains.

Grains: Rice, wheat, corn and soybeans are the main grains used for the purpose of this invention, but are not limited to these. Although some consider soybeans not to be included in grains, soybeans are included in grains for the purpose of the present invention.

Storage and Reserve: storing valuable objects for future use is reserve, but for the purposes of this invention, storage includes what reserve implies.

Real space and Virtual space: Real space is the place of real or actual society, and virtual space is the place of computer-generated society that is not real. Metaverse is characterized by the placement of avatars in a three-dimensional virtual space on the Internet as surrogates for people in real space, allowing them to interact with others, share space, and engage in social activities that are interconnected with the real world.

### SUMMARY OF INVENTION

### Technical Problem

Due to the establishment of the Dojima Rice Exchange, the issuance, distribution, and trading system of the kuramai-kitte, and its role and function as a point of contact between agricultural products and financial transactions should be highly regarded. However, with the technological level and social system of the time, there were issues such as the technology for preserving agricultural products, consistency between the amount of convertible notes to be issued and the amount of agricultural products to be stored, the means of information transmission and fairness, and the authenticity and liquidity of convertible notes.

The purpose of this invention is to provide a system for managing agricultural products, issuing convertible money for such products, and circulating such money using computer and network technology, based on the system of monetization of agricultural products, as learned from historical facts.

To this end, the aim of the present invention is to provide a money characterized by maintaining the credibility of money by means of a money backed by a physical object having value, to stimulate economic activities by increasing the liquidity of money, and to be convertible at any time, when needed, with a physical object of the denomination represented by the money. It is also to provide a means of indirectly guaranteeing those other currencies or tokens by their physical value through the money of the invention by pledging those other currencies or tokens with the money of the invention.

As shown in the history of the Dojima Rice Exchange, it is clear that kuramai-kitte that can be converted to agricultural products at any time, using agricultural products as collateral, i.e., money with that mechanism, is both useful and trustworthy.

The kuramai-kitte described in the Background Technology section are, in terms of their style and transaction form, convertible coupons similar to warehouse receipts, and can be said to be a monetization of tribute rice. The way a kura-yashiki issues kuramai-kitte and convert it into kuramai, the reserve rice for redemption, is similar to the way an issuing bank issues banknotes for redemption and converts them into the real value of gold, silver, and other metals, the reserve money for payout. However, in the case of kuramai-kitte, the kurayashiki will be unable to meet the withdrawal of kuramai by issuing karamai-kitte in excess of the amount of kuramai in stock, causing so-called dishonor or a run on the kurayashiki, which will damage the value of the kuramai-kitte issued by the kurayashiki causing such a situation and lower its rice price. Even if the money is promised to be convertible into physical object, there must be a system to maintain its credibility.

The trading unit at the Dojima Rice Exchange was 10 koku, which is about 1,500 kg today. In the modern commodity futures market, brown rice in Japan is traded in units of 1,500 kg, 3,000 kg, or 12,000 kg depending on the variety (Osaka Dojima Commodity Exchange), hulled rice is traded in units of 2,000 cwt=91 tons (Chicago Mercantile Exchange), corn is traded in units of 5,000 bu=127 tons (Chicago Mercantile Exchange), the trading unit for wheat is 5,000 bu=136 tons (Chicago Mercantile Exchange), and the trading unit for soybeans is 5,000 bu=136 tons (Chicago Mercantile Exchange), so naturally, the settlement amount for each trading unit is also high. Warehouse receipts are used for settlement in the commodity futures market. However, if these warehouse receipts, which represent one trading unit of agricultural products, were to be used as a convertible note for agricultural products for the purchase of general consumer goods like money, the unit would be too large to be used for settlement in general society.

By making one unit of money smaller, it is easier to use it in exchange for general consumer goods, i.e., to pay for them when they are purchased. However, the small-lot system makes it impossible to keep track of the large number of money issued and the produce to be redeemed on paper in ledgers and books, and the use of computers and networks is essential to authenticate the validity of the money, match the location and status of the produce to be redeemed, execute payment processing transactions, and complete transactions in a realistic amount of time.

In a monetary economy, the value of money has been secured by the standard currency or convertible money based on the gold standard. Today, the money issued by each country is credit money, and the law gives it compulsory acceptability, so that if the creditworthiness of a country is damaged, the value of the money is also damaged.

Therefore, it can be said that the value of money is determined by national power. And the value of money issued by a country with weak national power or unstable national conditions will naturally decline, causing a rise in the domestic inflation rate due to uncertainty about the future, and making it difficult to settle international transactions using that money. Since national power is measured by a country's assets and capabilities, such as people, politics, economy, military, resources, science, technology, culture, and information, as well as its influence on other countries, raising the level of these assets and capabilities will increase the country's money value.

In addition, in general, the economy improves when more money is issued, but even so, if the circulation of money stagnates and the circulation of that money becomes sluggish, the economy will stagnate. This occurs primarily when firms and individuals save money as an asset and do not turn it over to pay for goods and services. Even if the amount of money issued is not large, if the speed of its circulation is fast, economic activity will be smooth and the economy will improve. Although the amount of money issued can be increased or decreased by policy, it is difficult to control the speed of money circulation through policy. The decision to spend or store money is largely a matter of individual consciousness.

Since a decrease in the value of money leads to inflation and a decrease in the speed of money circulation leads to deflation, states and central banks, which are the issuers of money, will take various solutions. One solution to this problem is for local governments and the private sector to issue community money as a unique currency that circulates within a particular district, thereby preventing the retention of money and encouraging consumption by keeping consumers in the community.

One example of a currency that has been introduced to increase the speed of circulation by setting an expiration date on the money or by introducing a system whereby the money depreciates at regular intervals is the WIR, the Swiss community money. The WIR is a mechanism that depreciates the purchase of stamps from the currency by requiring the purchase of stamps equivalent to a portion of the face value of the currency at regular intervals to maintain its value, thereby encouraging circulation rather than allowing the currency to be saved. This is a monetary system that embodies the idea of depreciating money as proposed by Silvio Gesell. By charging positive interest on money, the saving of money generates a profit from interest, and by charging negative interest on money, the saving of money leads to depreciation. This mechanism is based on the idea that a mindset that encourages people to use money for consumption will have the effect of stimulating the circulation of money and economic activity. This idea and means were introduced and evaluated by John Maynard Keynes in his General Theory (1936). Keynes himself proposed the International Clearing Union as a Keynesian proposal for a post-World War II framework for an international monetary system, in opposition to Harry Dexter White, who proposed a preliminary draft of the Allied International Stability Fund proposal. The Keynesian proposal would establish a clearing and settlement union that would function as a world central bank and a new currency, the bancor, to handle international settlements, with each country using the bancor account established in the clearing and settlement union to make settlements among countries through mutual transfers. The system was designed to prevent certain countries from overaccumulating bancor by charging negative interest to countries with balance of payments surpluses. This is intended to help countries with balance of payments surpluses move toward trade promotion and balance of payments equilibrium without accumulating their settlement currency.

The concept of giving issued money a life of use, or depreciating it, was almost unheard of in money until today. Generally, the life of money is the physical life of a banknote or coin, and in that situation, the value of the money is maintained by replacing it with an equivalent new banknote or coin.

Thus, various measures and considerations have been made to control deflation and inflation.

The means of support for agriculture in many countries is the protection of domestic agriculture through the provision of subsidies to farmers and agricultural products, import restrictions on agricultural products coming from other countries, and the addition of tariffs and other duties. However, these policies can become barriers to international free trade and cause financial pressure on the country.

In the creation of money convertible to agricultural products, the main factors that determine its value are prices, supply and demand for agricultural products, and hedging against other currencies. In order to operate a money convertible to agricultural products, it is necessary to produce agricultural products on a scale commensurate with the amount of money issued and to generate profits for producers of agricultural products through production costs that adjust to the prices expected by the market.

The issuance and circulation of money can be automated through computer systems, but the agricultural products used for money conversion are produced by farmers, while cooperative associations and producer groups handle production management and the operation of shared facilities. Through collective decision-making, it becomes possible to produce a sufficient amount of agricultural products that corresponds to the issuance of the currency. Additionally, cooperative associations and producer groups play a significant role as organizations for implementing the monetary system. They are involved in the construction and operation of shared facilities, the introduction and shared use of production equipment, the development of infrastructure such as irrigation water, the joint transportation of agricultural products, the construction and operation of storage facilities for agricultural products, and the inspection and certification of agricultural product quality. They also play a role in resolving human emotions that cannot be addressed by computer systems, such as pursuing planned productivity, resolving conflicts among producers, and adjusting interests. This means that cooperative associations and producer groups have a major role in establishing and controlling large-scale agricultural production systems.

In implementing a monetary system convertible to agricultural products, taking rice as an example, various processes are required. These processes include rice production by farmers, rice collection at collection sites, quality inspection through sampling, drying and preparation processes, storage, and inventory management. Additionally, equipment and machinery such as weighing scales, moisture meters, quality inspection machines, drying machines, country elevators or storage facilities, threshers, rice polishers, sorters, and packaging machines are necessary. Similar processes involving these facilities and equipment apply to grains other than rice. For other agricultural products, appropriate procedures and equipment are required depending on their storage methods, such as freezing facilities or drying equipment.

A major challenge in the production process of such agricultural products is the funding required for facilities, equipment, and infrastructure. Even if there is available farmland and labor, it is difficult for individual producers to bear the initial costs and production costs required to produce a sufficient amount of agricultural products for currency conversion. Therefore, production through cooperative associations or other community-based entities is desirable. In such cases, individual producers, as members of the cooperative association, strive to minimize their cost burdens while seeking the right to use shared resources. This often leads to conflicts among producers.

### Solution to Problem

The money and monetary system of the present invention are constructed through a combination of multiple elements, and the configuration that constitutes the present invention is determined by the combination method and implementation mode.

Therefore, the role of each of the components of the invention will be explained, as well as the technical feasibility of each element in turn.

The invention consists of an agricultural product to be used for converting money, a storage facility to store and manage the agricultural product, money to be issued in proportion to the amount of stored agricultural product, a system to circulate and trade the money, a system to convert the money to stored agricultural product, and a computer and network to integrate and control these processes.

First, the following is a description of the money of the invention.

The requirements for the money to be established as money in the present invention are as follows:
1. It should possess credibility either through the issuer or the money itself.
2. The value of the money should fluctuate based on factors such as prices, popularity, and other elements.
3. The total issuance of the money should be restricted under specific conditions.
4. The money should be exchangeable with other money or currency units, and the exchange should be easy.
5. The money should maintain its existence either indefinitely or for a specific period, whether in tangible or intangible form.

These aspects generally align with the characteristics of legal tender. In terms of the credibility of currency, one means to obtain it is through the issuance of legal tender by a credible central bank or similar entity, which is guaranteed by the state or other governing authorities. Another way to establish the credibility of currency is by securing it with valuable assets corresponding to the face value of the issued money, ensuring that the money can be exchanged for those assets at any time. This is similar to the mechanism of convertible currency in a gold standard system. Furthermore, the basis for maintaining the credibility can be upheld by monitoring whether valuable collateral equivalent to the issuance amount of the money is held, either by the state, government agencies, or auditing institutions.

The money in the present invention is characterized by being issued and circulated through an electronic means, without requiring physical forms such as paper notes or coins. This differs from the use of tangible certificates, such as kuramai-kitte at the Dojima Rice Exchange or modern warehouse warrants, in transactions. By means of electronicization of money, the present invention can be realized.

In the monetary system of the present invention, it is possible to utilize known technologies for the mechanism of electronic currency circulation and transactions. Specifically, it is possible to construct a proprietary blockchain and employ means similar to cryptocurrencies like Bitcoin or Ethereum for the circulation and transactions of the currency, as well as implement tokens based on these blockchain technologies. Moreover, these means allow for the implementation of practical security measures using existing technologies.

The following is a description of the agricultural products used to convert the money.

As for the types of agricultural products used in the present invention, grains are particularly suitable as they have good storability and can maintain their quality over a long period of time under appropriate storage conditions. In particular, major grains such as rice, wheat, corn, and soybeans can be stored for several years without significant quality degradation. Other agricultural products that can be considered are dried crops and frozen crops, which can be stored at suitable quality for a certain period of time. Agricultural products have various applications, not only as food but also as feed and industrial raw materials, and there is potential demand for aged products. The specific duration for determining suitable quality depends on the intended use of the agricultural products, but for the purpose of the present invention, a period of 1 to 5 years is desirable. These agricultural products form prices that reflect the prevailing price levels and supply-demand relationships, thereby naturally determining the value of the money that can be exchanged for them.

The agricultural products used for conversion need to meet certain criteria for variety, quality, and standards during the receiving process at the storage facility. It is also necessary to store them in a way that their quality does not significantly deteriorate over a certain period of time. Country elevators play a role in fulfilling these requirements, and their usefulness and the means of managing agricultural products are already known. In addition to country elevators, other storage facilities such as cold storage warehouses are also available. The production volume of agricultural products varies due to natural environmental factors, and the storage volume fluctuates depending on supply and demand. Therefore, it is necessary to constantly monitor the inventory status of agricultural products, measure and weigh them, and manage the storage volume of agricultural products that meet certain quality standards using computers. The measurement unit for the quantity of agricultural products can be based on either weight or volume.

The monetary system of the invention will operate and manage the process of issuing money in an amount commensurate with the amount of agricultural produce stored for conversion, using blockchain technology and cryptography to securely circulate that money and use it for transactions, exchanging the money of the invention for legal currency or tokens, or exchanging legal currency or tokens for the money of the invention, and converting the money of the invention to agricultural produce, on computers and on networks.

Crypto assets, while there are concerns about the basis and assurance of the value of the currency itself, the money of the present invention has a value in terms of prices, since it is convertible to agricultural products. In addition, as for the maintenance of order in currency circulation, which has been a problem in crypto-asset transactions, the present invention provides a check function to maintain fairness and openness, with timely and appropriate auditing by a reliable government agency or third-party organization, etc. In particular, it is possible to check whether the issued money is properly secured by agricultural products and whether the agricultural products maintain their quality, and to audit whether the money is issued by a legitimate organization and whether the agricultural products are of good quality. The agency that issues the money should be separated from the agency that evaluates and audits the legitimacy of the money. According to this, the issuance of money does not have to be done by the state, a national agency, or an international organization, but can be done by the private sector, for example, by cooperatives or producer associations that produce agricultural products, or by private companies such as financial institutions that trade in money or currency. In such cases, the state may directly or indirectly audit and control the money system.

Since the money is stored in a country elevator or other storage equipment in an amount of agricultural produce commensurate with the amount of money issued, the holder of the money can use the money, which has the value of the agricultural produce at that time, to pay for general consumer goods, such as goods and services. This depends on whether or not the recipient of the money for this payment trusts and believes in the money and accepts it in the transaction. In the case of the money of the present invention, the trust is obtained by comparing it with the market value of the produce, which is recognized by everyone.

As an implementation of the present invention, economic activity can be stimulated by giving money a life span as a time limit for its use. As a technical means to realize this, the money is, in principle, an electronic intangible, consisting of blocks of data or programs. Computers and networks are indispensable, and as elements of the monetary system, data processing for the storage of agricultural products and data processing for the control of the issuance and circulation of money will be linked.

The concept that money has a life span was proposed based on the deterioration over time of the value of agricultural products used to convert money. The life of money is equivalent to setting a time limit for its use, which is intended to increase the economic effect of money by inducing its holders to intend to put it into circulation before that time limit, thereby increasing its liquidity.

In addition to the value of the agricultural product itself used to convert the money, transaction taxes, agricultural subsidies, and transaction fees can be included in the value of the money as components of value.

The money has the opportunity to change the parameters of the data that make up the money in a timely manner, since it can be used for a finite period of time. The opportunity is the point in time when the value of the money is reduced to zero and it naturally disappears, either by exchange for new money at a financial institution or exchange office, exchange for other money or currency, conversion of money into agricultural products, or by depreciation due to the withdrawal of money. For continuity of value and fairness in monetary transactions, it is better to maintain the parameters of the money before the transaction and after the transaction. However, if the payer's money is cancelled after each transaction and a new equivalent money is issued and given to the recipient, the point in time of the money transaction can be used as an opportunity to rewrite the parameters of the money.

The money is an intangible form of electronic money composed of data and programs. The means of circulating it and using it for transactions can be realized with technologies used for electronic money or crypto assets, which are known and practical. The data structure of the money may be in ISO 20022 format, an international standard for its compatibility with financial transactions, or a smart contract mechanism may be introduced to automate the execution of transactions. According to smart contracts, it is possible to automatically collect the prescribed fees and taxes at the time of money issuance and transactions, and automatically programmatically execute processes and transactions such as allocating the money or the cash convertible into it to the respective accounts. The mechanics and technology of smart contracts are known, especially with their implementation in the field of crypto assets.

The money and the monetary system will be effective if it is operated in each region of production of the same type of agricultural product used to convert money. This is because when a holder of money wishes to convert it into an agricultural product, the exchange or converting office where it can be converted is usually located within the production area of that product, and therefore, it is intended for those who are geographically accessible to that area. However, solely for the purpose of exchange and arbitrage of such money, or for the purpose of reinsuring other money or currencies, the conversion of such money into agricultural products need not be considered, and the area of circulation of such money need not be limited to the area of production of such agricultural products.

The money can be used as a substitute for agricultural products used to convert it, facilitating agricultural transactions, and can also be used as a means of payment for the purchase of general consumer goods using the money. In order to use the money for payment, each unit of the money should be small enough. For example, one unit of money should be equivalent to one US dollar, one euro, 100 Japanese yen, or one Chinese yuan, and the amount of produce should be guaranteed to be equivalent to that amount. Alternatively, the international price of major grains, which are agricultural products suitable for the purpose of this invention, is generally several hundred US dollars per ton of grain, although it fluctuates depending on factors such as type, producing country, consuming country, supply and demand, and exchange rates. Therefore, issuing one unit of money convertible to 1 kg of grain would be a sufficiently small amount of money. If necessary, the number of significant digits in the money calculation can be made valid up to two or three decimal places, or a supplementary unit of money can be issued to cover a wide range of prices. Considering the handling of agricultural products and the liquidity of money convertible to agricultural products, the amount of agricultural products that can be converted into one unit of money should be in the range of 100 g to 100 kg in weight, or 100 cubic centimeters to 1 cubic meter in volume.

To obtain the money, the producer of the agricultural product used to convert the money has the opportunity to selectively exchange the agricultural product for the money by bringing the agricultural product to a cooperative or other collection point. Those who are not producers of the produce may obtain the money by exchanging it from legal currency or crypto assets at a currency exchange office or a financial institution that handles the money. They may also receive the money in the transaction of goods.

The money can be used not only for transactions between parties involved in agricultural transactions, but can also be used for the same purposes as currency or crypto assets are used for commercial transactions, payments, or remittances of general consumer goods. While most crypto assets cannot guarantee their own value, the money of this invention is guaranteed by agricultural products and, of course, has a certain value. This means that the basic requirements of money are fulfilled by the real value reflecting prices and current conditions, and transaction participants have a basis to use this money for general commercial transactions, settlements, etc., based on its value and credibility.

An important mission of the state is to protect the lives of its citizens, which includes food security. For example, stockpiling major grains for a certain period of time is an important national policy. However, the national stockpiling of food requires a huge amount of money and is a major burden on national finances. Using the proposed monetary system, the state can issue and circulate money using the stockpiled agricultural products as collateral, thereby liquidating the stockpiled agricultural products in the form of money, which can then be used in financial transactions to generate revenue. The stockpiled agricultural products can be liquidated in the form of money, which can then be used in financial transactions to generate income, and can be invested in financial instruments that are re-secured with the money. In the event that the nation needs to release stockpiled agricultural products in an emergency, it can convert its own money into agricultural products or purchase money from the market that corresponds to the amount of agricultural products to be released, and release the agricultural products from stockpiles to fulfill the role of the national stockpile.

Assuming that not all of the issued money is immediately converted to agricultural products, the issuer of the money or the system operator can expect to receive commissions from the settlement of general consumer goods during the period the money is in circulation, or guarantee fee revenues from the use of the money as a reinsuring instrument. In addition, if the state imposes a transaction tax or property tax on the money, it will receive tax revenues.

The value and credibility of the money system is based on its convertibility to agricultural products. Pursuant to the stipulation of the quantity of agricultural produce to be converted into one unit of money, the holder of the money has the right to demand from the issuer of the money the conversion of the money held into agricultural produce, and the issuer of the money may obtain credit by stipulating that it is obligated to convert the money.

Therefore, it is important that the amount of money issued be balanced with the corresponding amount of agricultural produce in storage. However, agricultural products have production risks due to natural conditions and disasters. In the system of the present invention, as inventory management in preparation for risks, a means of inventory adjustment is proposed by means of dispersion of production areas of agricultural products and control management by a network, as well as by means of two levels of storage equipments and a reserve storage equipment. In the event that the inventory in the main storage equipment falls below the amount of produce required to convert the outstanding money, the storage equipment will be replenished with produce from the reserve storage equipment, or produce will be newly received and stored in the storage equipment. If this is not possible, money is repurchased to match the amount of agricultural produce in storage to balance the amount of money and the amount of agricultural produce in storage needed to convert it into money. However, there may be cases where it is not possible to buy back the outstanding money due to the condition of the money in circulation in the market, or where buying back the money would cause a significant reduction in the liquidity of the money. In such cases, temporarily adopting another agricultural product with as much similarity and linkage as possible as an alternative agricultural product could be a solution. Furthermore, since the money has the dual nature of money and agricultural products, hedging in both the money market and the commodity market can be a means of preserving the compensation for convertibility and maintaining credit.

As described above, the present invention is a money system that can be implemented by a computer and network-based system to solve the previous problems. The implementation of the system is broadly composed of leading the amount of money issued according to the amount of agricultural products stored, or leading the amount of agricultural products stored according to the amount of money issued.

One is: An electronic money convertible to agricultural products, which defines the quantity of the agricultural products to convert one unit of the money, and controls the quality and storage quantity of the agricultural products by computer. Based on the quantity of the produce stored, the money is issued in an amount commensurate with the conversion of the produce with the appropriate quality in storage. The money is circulated through a network for transactions, and a computerized system is used to control the consistency between the amount of produce stored and the amount of money.

Or: An electronic money that is convertible into agricultural products, which is circulated by a network and used to convert the money. The amount of the produce to convert one unit of the money is determined, and based on the amount of the money issued, a quantity of produce of suitable quality is stored that is suitable for conversion in the amount of the money. The system is to be computerized to control the quality of the produce and the quantity stored, and to computerize the consistency between the quantity of produce stored and the quantity of money.

### Advantageous Effects of Invention

The monetary system of the present invention provides an economic incentive for farmers to sell their produce at a premium compared to the normal transaction price by allowing farmers to receive the money for their produce at the collection point. The monetary system of the present invention provides an economic incentive to the producers of agricultural products, and increases their motivation for production. In addition to the value of the agricultural product itself, the value of the money will be added as a premium by the participants in the transaction, who are expected to own the money. A mechanism can be designed to return this value to the producers.

Even if each producer issues money based on its own agricultural products, it is difficult to provide liquidity, convenience, and conversion of money in a broad market. Therefore, the production of agricultural products used to convert money should be organized by producers' associations or cooperatives. Producers of agricultural products will benefit from the introduction of this money system and the introduction of common goods through organized production, which will result in higher productivity and better gains when acting as members of a cooperative than by a single producer. This is because, if the expenditures of divisible costs and common costs and their gains are formulated and verified by game theory, the common costs can be raised by issuing and operating the money of this invention, eliminating or reducing the burden on each party, eliminating the main cause of conflict of interest and increasing the motivation and incentive of producers.

Increasing farm income depends on either increasing the production of agricultural products or raising the price of agricultural products. However, if the yield of agricultural products increases, resulting in what is called a good harvest, agricultural product prices will decline, and farmers will not be able to fully enjoy the income benefits of increased production. Conversely, when the production of agricultural products decreases due to weather and other factors, or in the case of a poor harvest, the price of agricultural products rises, but the overall income does not increase due to low yields. In the agricultural commodity market, there is a commodity futures market, although limited to certain agricultural products, where farmers can hedge the yield and price of their agricultural products to stabilize or increase their income. By using the money in transactions, such hedging can be easily implemented as a monetary transaction, which has the effect of contributing to stabilizing and increasing farmers' income.

In addition, since the issue of the money can be set up so that the cost of the basic common goods of the cooperative to which the producer belongs is added to the money, it is possible to raise funds through the issuance of money to pay for the costs, thereby solving the problem of agricultural development due to difficulties in raising funds.

The money is expected to be utilized in agricultural commodity transactions in the commodity markets and to be developed into financial derivatives based on such transactions. The mutual linkage between those financial transactions and commodity transactions will have the effect of expanding and activating the volume of transactions in those markets.

As agricultural commodity prices fluctuate with agricultural commodity market conditions, the value of the money of the invention will naturally fluctuate as well. Depending on how the invention is implemented, the money may depreciate, but the value of the money may also increase due to rising prices. In such a case, the money can be exchanged for another money or currency, thereby earning a capital gain on the acquisition of the money and on the sale of it. In the past, the pursuit of capital gains from price fluctuations of commodities was done in the commodity market, but this requires specialized financial knowledge, and the procedure is not easy when it comes to physical settlement. However, the money system of the present invention makes it possible to do so as a money transaction or in the financial market.

The issuing institution or the government of the country of issue can introduce a system whereby the issuing institution or the government of the country of issue earns revenue from the money itself by adding fees or taxes when issuing or transacting the money of the invention. This could be through issuance fees, transaction fees, issuance taxes, transaction taxes, asset taxes, etc.

The money and the monetary system of the present invention can be used by the holder of the money for transactions in the commodity and financial markets, and can also be deployed for the settlement of daily general consumer goods to enjoy the convenience of payment. Furthermore, the convertibility of the money system to agricultural products allows for the conversion of the money to agricultural products at a conversion office even in times of inflation or when agricultural products become difficult to obtain from the general market. This has the effect of insuring the availability of food, and this in turn motivates people to hold this money, which adds a premium to the value of the money.

Furthermore, according to the money and the monetary system, for example, when food aid is provided between countries, a supporter in another country can purchase money that is convertible to agricultural products produced in the target country, and send the money to a person in the target country who wants to support the recipient through the network. The recipient of the money can then convert it into agricultural products in their own country to obtain food. This system is also effective as a mechanism for in-kind donations to the poor.

### BRIEF DESCRIPTION OF DRAWINGS

FIG. 1 is a conceptual diagram according to one or more embodiments.

FIG. 2 is an explanation drawing of a movement of agricultural products in a storage facility.

FIG. 3A is an explanation drawing of a depreciation of a money.

FIG. 3B is an explanation drawing of a depreciation of a money.

FIG. 3C is an explanation drawing of a depreciation of a money.

FIG. 3D is an explanation drawing of a depreciation of a money.

FIG. 3E is an explanation drawing of a depreciation of a money.

FIG. 3F is an explanation drawing of a depreciation of a money.

FIG. 4 is an explanation drawing of an example of depreciation of a money.

FIG. 5 is an explanation drawing of an offline transaction flow.

FIG. 6A is a flowchart of a monetary system.

FIG. 6B is a flowchart of a monetary system.

FIG. 6C is a flowchart of a monetary system.

FIG. 6D is a flowchart of a monetary system.

FIG. 6E is a flowchart of a monetary system.

FIG. 6F is a flowchart of a monetary system.

FIG. 6G is a flowchart of a monetary system.

### DESCRIPTION OF EMBODIMENTS

Since the money and the monetary system of the invention is composed of several processes and can be modified according to various conditions, an example of the overall structure of the invention is described in Example 1, and examples of the implementation of each process and condition are described in Examples 2 through 11, with drawings.

### Example 1

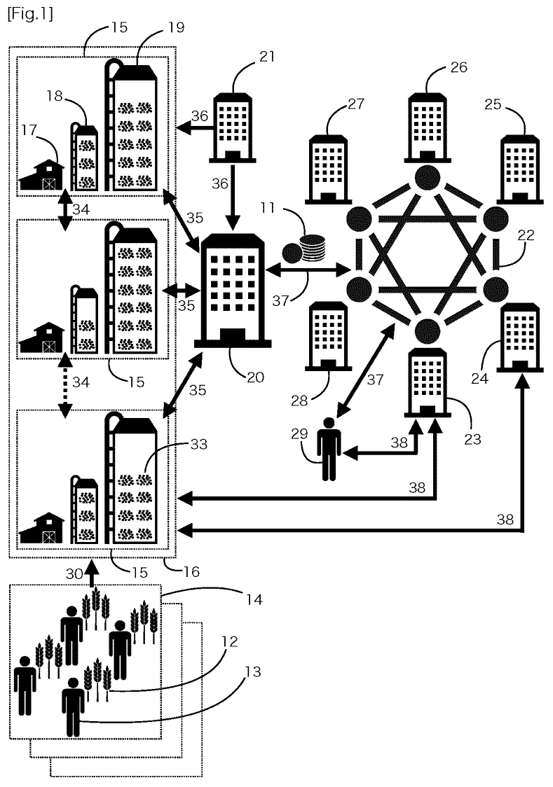

The concept of the invention is explained along with FIG. 1.

The issuance and distribution of the Money of the present invention11 will be carried out through the cooperation of several facilities and institutions and existing organizations. The organization and system consists of Agricultural product producers13 of Agricultural products 12, Agricultural cooperative or Agricultural producers group14 to which the Agricultural product producers13 belong, and Storage facilityl5 for agricultural products, which Receiving30 consignments of agricultural products. If the agricultural products are produced over a wide area, multiple Storage facilityl5 are connected by a network to form a Storage facilities group16. There is a System operation organization20 that is responsible for the issuance and circulation of the money convertible to the agricultural products stored in these storage facilities. The system operating agency, as a data center, builds the system of the invention, manages the issuance, distribution, transactions, and settlement of the money and the monetary system, as well as the inventory of agricultural products used to convert the money and the process of converting the money to agricultural products, and transmits the data and parameters necessary for this through the communication network.

The monetary system of the present invention can be subdivided into different types or varieties of agricultural products, and for each of them, many kinds of the money of the present invention that are convertible to each of them can be issued.

Storing the agricultural products at a certain quality for a certain period of time is an important process, as is the conversion of the money of the invention to the produce.

Here, the storage process is explained using rice, a major agricultural product and the main grain, as an example.

During the Edo period in Japan, rice traded at the Dojima Rice Market was stored in warehouses in the kurayashiki, but storage technology at that time was poor. In modern times, however, storage technology is highly controlled in country elevators. Rice immediately after harvest has a high moisture content and is dried for storage. Drying reduces damage to quality caused by wastage of components, generation of respiration heat, and mold. Rice received30 from Agricultural product producers13 or Agricultural producers group14 at an Agricultural products collection center17 is in the state of hulled rice. In order to maintain a certain level of quality, the received hulled rice is sampled and made into brown rice using an impeller huller, etc., and then analyzed for composition using a visible light analyzer or grain discriminator, etc., and for composition using a near-infrared analyzer, etc. The rice is then sorted by visible light analyzers, grain discriminators, etc. After inspection and preservation processes such as drying, agricultural products are stored in silos at country elevators in the state of hulled rice, or in bags in the state of brown rice and stored in warehouses. Globally, rice is generally stored in the unhulled state, but in Japan, due to its historical background, it is sometimes stored in the brown rice state. In this storage, it is important to control the moisture content and temperature of the rice. By maintaining the degree of dryness and storing the rice at low temperatures, the quality of the rice will not deteriorate and can be maintained for one to several years, which is necessary to guarantee the conversion of the money of the invention.

In this example, it is proposed to store rice in two stages: a Preliminary storage equipment18 and a Main storage equipment19. A Storage facilityl5, consisting of a collection area, a preliminary storage facility, and a main storage facility, is located in several locations to form a Storage facilities group16 if the rice production area is large. At the group of storage facilities, Transfer of agricultural products between storage facilities34 as needed to maintain the monetary system of the invention.

When converting the money to rice, it is preferable in Japan to use the brown rice conversion, as it is consistent with the fact that the standard for physical offerings in commodity futures trading is brown rice. Internationally, in regions where rice is stored and traded in hulled rice, conversion to hulled rice is preferable.

Next, the mechanism for issuing money convertible to stored rice is described.

The linking of the amount of money issued to the amount of rice stored as the object of its conversion can be done by adjusting the amount of rice stored to the amount of money issued, or by issuing money in proportion to the amount of rice stored. For example, if it is set up so that one unit of the money can be converted into 1 kg of rice, a corresponding amount of rice is stored. In this case, by using a computer and network to manage the stock of rice and control the issuance and circulation of the money, one unit of the money is always issued and circulated with the substance of 1 kg of rice. It is a system whereby one unit of money always represents the value of rice reflecting the prices of the time and is always convertible into 1 kg of rice.

The issue of money and the storage of rice are interlinked, and the correct storage of rice corresponding to the amount of money issued is a matter of trust and confidence in the money and monetary system of the invention. Therefore, credit is maintained through Audit36 conducted by government agencies and third-party Audit organization21 on the quantity and quality of rice stocks corresponding to the money issued.

A Storage data 35 is transmitted between each storage facility and a System operation organization20 to manage the storage status of rice, calculate the amount of rice stock required for the issuance of the money, and issue the money in the amount commensurate with the amount of rice stock. Since the money is electronic money, it is distributed through a Communication network22, and a money data37 is transmitted between the network and the system operator. The network is connected to a Money exchange store or a Money convertible store23, Commodity market or Commodity futures trading market24, Financial market or Financial futures market25, Crypto asset exchanges or Crypto asset market26, Government agency27, and Financial institution28 that are involved in the transaction of money, and Trading participant29 can trade in money or convert38 it into rice.

The liquidity of the money of the present invention can be effected by issuing money that has a life span as a use-by date or that depreciates. This is closely related to the fact that the money of the present invention is characterized by its convertibility into agricultural products.

In the case of rice, for example, with proper preservation and storage measures for rice it is possible to maintain a certain quality for several years after harvest. In many countries, stockpiled rice is stored for the purpose of providing a stable food supply for the people. For example, the quality of rice is maintained for a period of three years, and every year one-third of the stockpile is renewed by sequentially replacing it with new rice on a first-in, first-out basis to maintain the quantity and quality of the stockpile. In other words, newly harvested rice is maintained at a constant quality level for three years, and rice that has been in the storage equipment for three years is forced to be consumed or disposed. If this is to be associated with the issuance of the money, it can be set up so that money is issued for newly harvested rice, and that the money will also reach the end of its life after three years, when the rice has reached the end of its quality life. In this case, there are several options for the life of the money. For example, if three years is the life of the money, the value of the money can be kept constant from the date of issue to the date of the life of the money, and at the end of the three-year period, the value of the money can be reduced to zero. Or, in the course of the three-year life, the value of the money depreciates at a certain rate each day, month, or year, and is reduced to zero by the end of the three-year period. Furthermore, the value of the money may be set to be constant for one year from the date of issue, and the money may begin to depreciate after one year has passed. This is in line with the general trend to call the first year of rice harvesting “new rice” and treat it differently from the value of rice after that period, and is also convenient for conforming to the physical commodity standards for physical offerings in physical settlement of commodity futures transactions, etc. Here, the practical product life of rice is set at three years. Although it is possible to store rice for a period longer than three years, maintaining a certain level of quality, due to improvements in preservation technology, in implementing the present invention, considering the costs associated with storage and the purpose of setting an expiration date on the money, the expiration date should be limited to 10 years. In order to increase the turnover rate of stored inventory, or depending on the rice harvest cycle, the time limit can be set shorter, for example, one year.

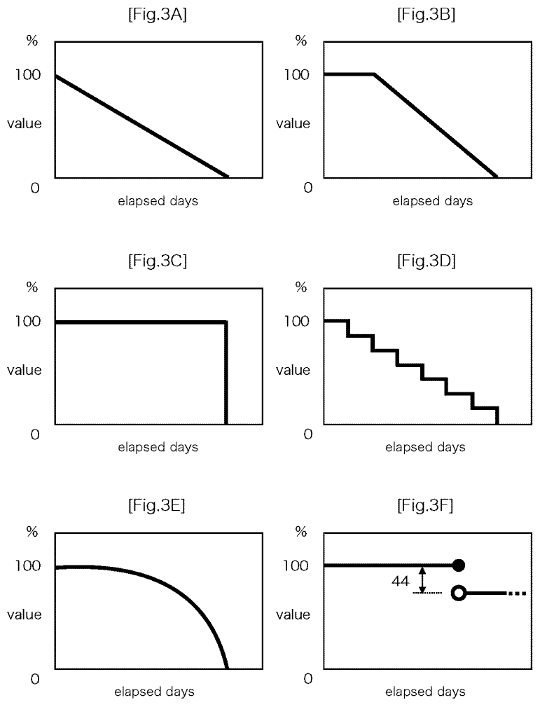

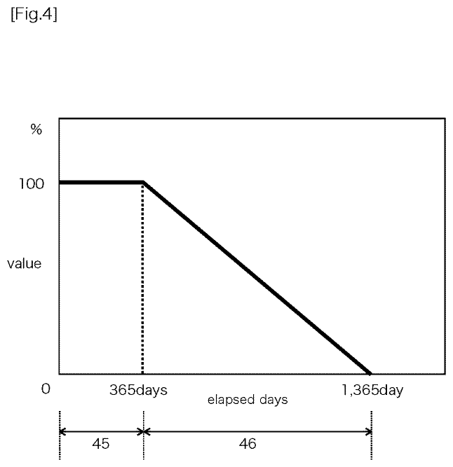

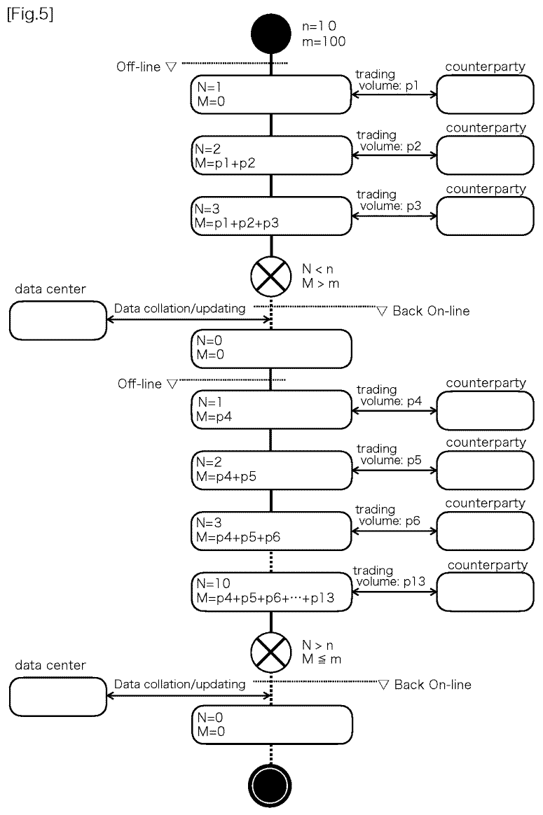

According to another logic, the rice used to convert the money is stored continuously by replacing the stored rice on a first-in, first-out basis by receiving newly harvested rice, always maintaining a certain quality, and thus the value of the entire money issued relative to the total amount of rice stored is also considered to be sustainable. The value of the entire money issued in relation to the total amount of stored rice can also be considered sustainable. According to this, the value of the money does not have to depreciate at a specific expiration date, and a system can be devised to renew the expired money into a new money with a denomination equal to that of the previous money. According to this implementation, a system could be designed to automatically renew newly issued money at the expiration date with a newly issued equivalent money of the invention, although the newly issued money will reach the end of its life at an arbitrarily set expiration date. The mechanism for depreciation of these monies is explained in Example 5, using FIG. 3A through FIG. 3F and FIG. 4.

The money can have a life span. A process can be included to start depreciating the money from the time it is issued or from the time it is received through a transaction or other means.

The money may be obtained by a Agricultural product producer13 who receives the money when the rice produce delivers the rice to the agricultural products collection center, by a Trading participant29 such as an ordinary consumer who converts the money to another money or currency at a financial institution or money exchange store that handles the money, or by obtaining the money from another holder of the money through a transaction. Each of the money acquired in this way has a money issue date. Each such money has an issue date and depreciates or expires based on a value determined by parameters starting from the date of issue or acquisition.

The following is an example of rice as an agricultural product. The value of the money is determined by the physical value of the rice used to convert the money, but incidental to the value of the money are the costs of receiving, storage, inspection, quality maintenance, paperwork, depreciation of equipment, and other costs associated with maintaining the monetary system of the invention. In addition, transaction fees, transaction taxes, property taxes, insurance premiums, subsidies, etc., as maintenance costs and profits of the institution issuing the money and tax revenues of the state, are involved in the formation of the value of the money. By adding all or part of these ancillary elements to the value of the money, or by collecting them separately at the time of a transaction, the monetary system of the present invention can be operated in a stable manner. Furthermore, whether these costs are included in the value of the money or collected separately, they can be collected in kind in the form of rice used to convert the money by subtracting them from the balance of the transaction participant's money holdings. The rice collected as a tax can be used as a source of funds for the operation of the money system, and the rice collected as a tax can be used to build up the national reserve, and the rice sold in the market can be recovered in legal currency.

The issued money of the invention can be traded as a substitute for physical rice. In other words, once a person in need of rice acquires the money, that person can convert the money into physical rice at any time at the money convertible store or the money exchange store, taking into account the depreciation schedule and life parameters set for the money. The depreciation schedule, which defines how the value of the money is to be reduced over the life of the money, is explained in Example 5.

The money can be used for settlement in the market like currency, so that when purchasing general consumer goods, payment can be made with the money instead of with currency, or the holder of the money can transfer the money to another party. Since the money has the character of a money as well as the quantity of rice itself that it represents, it can be circulated by the financial settlement system as a means of payment for goods or remittance of money, just as currency is.

Since the first money issued or transacted first will depreciate or reach its end of life first, the system should automatically compare the data of each holder's money to determine the settlement order and execute the transaction based on the first-in, first-out principle.

To convert the money into physical rice, the convertible claimant specifies the amount of money to be converted within the limits of the balance of money held at the money exchange store or the money convertible store that handles the money, and receives the physical rice. In this case, the various expenses may be reduced from the balance of money held by the convert the money claimant to settle the account. Upon execution of the physical liquidation, the monetary system reduces the amount of money for liquidation from the money holdings of its convert the money claimant, the liquidated money is extinguished, and the physical amount of rice converted is reduced from the storage equipment storage volume data.

The above description uses rice as an example, but other grains and other agricultural products will be handled accordingly. In addition to targeting a single agricultural product, the issuance of the money and the operation of the monetary system can be based on other varieties of the same agricultural product, different production areas of the same agricultural product, or a combination of many different agricultural products. This can have the effect of softening the fluctuations in the value of the money when the production of a single agricultural product or a single variety is limited, or when the fluctuations in the value of a particular agricultural product are flattened by the value of other agricultural products.

### Example 2

The following is a description of the means of storing produce used to convert the money.

Since the money and the money system require agricultural products to be used for converting the money to be issued, the agricultural products must be inspected and received to ensure that they meet the appropriate quality, entered into storage equipment, and maintained at a certain quality for the duration of the storage period. For this purpose, the quality and standards for agricultural products to be used for conversion shall be specified, their conformity shall be evaluated, and agricultural products that meet the standards shall be designated as Conforming quality agricultural products.

Even if all of the issued money is to be converted the money to agricultural products, there must be sufficient storage to make this possible. That storage would come from storage equipment such as country elevator silos or storage warehouses. Basically, the amount of money issued should be linked to the amount of agricultural products stored for use in converting the money, but it may not be possible to increase or decrease the amount of agricultural products stored in response immediately to the supply and demand of the money. If the amount of agricultural produce stored for conversion the money is greater than the amount of money issued, the operation and reliability of the system will not be a problem. However, if the amount of agricultural products stored for conversion is less than the amount of money issued, the system may not be able to convert the money, which would undermine the reliability of the money and the system. In order to maintain a stable system of linking the amount of agricultural products to the amount of money issued, the agricultural products necessary for the operation of the money system should be stored separately and managed in storage equipment dedicated for that purpose, and in addition to the main storage equipment, the storage facility should have a reserve storage equipment in front of the main storage equipment to store the agricultural products. According to this means, even if agricultural products in the main storage equipment are damaged due to some kind of disaster or accident, they can be quickly compensated. This measure is also effective during the off-harvest period of agricultural products and as a measure to prepare for future harvest failures.

In addition, as the amount of agricultural products in storage equipment decreases due to the conversion the money, the amount of money issued also decreases, resulting in a shortage of money in circulation and a decrease in the liquidity of the money. The decrease in the quantity and liquidity of money, like that of currency, reduces economic activity. Therefore, the amount of money issued must be adjusted in a timely manner and, if necessary, it must be increased. In such cases, if there is not enough agricultural product in the main storage equipment, new money cannot be issued. To prepare for the issuance of additional money, agricultural products can be stored in reserve in the reserve storage equipment, and the necessary amount of agricultural products can be transferred to the main storage equipment for adjustment.

Furthermore, while the principle is that the money and the monetary system must have a sufficient quantity of agricultural products in storage at the time of issuing money to convert the money, it is acceptable to issue money in anticipation of agricultural products that are expected to be received and stored reliably in the future, even if there is no equivalent agricultural product in storage at that time, within a period acceptable to maintain the reliability of the convert the money.

If there is a shortage of the agricultural products used to convert the money in the region where the money is issued, the system can be maintained by replenishing it with agricultural products of the same kind from other regions, whether in the country itself or in other countries, or with the money of the invention that is convertible to such products, taking into account the cost of transporting such products between the regions.

The issued money may not necessarily be for the entire amount of agricultural products, but a limited amount of agricultural products may be accepted as consignments for the purpose of the proposed system. In such cases, the agricultural products to be accepted from producers for this purpose can be tendered in order to maintain fairness, so that there is no bias among producers depending on the time of production or the amount of production.

Furthermore, if the distribution area for the money and agricultural products to be used to convert the money is extensive, the agricultural products will not be stored at a single storage facility, but at multiple locations. In this case, the agricultural products to be used to convert the issued money should be stored at one of the storage facilities within a group of multiple storage facilities, and the total amount of agricultural products used to convert the money within the group of storage facilities and the total number of money issued will be managed in an integrated manner so that they are commensurate.

If a single agricultural product can be harvested over a wide geographic area of the same variety and comparable quality, it can be stored on a large scale and a single money based on it can be issued in large quantities. In such a case, there would be multiple storage facilities within a region, and weather conditions, pests, and other factors could create disparities in production among districts within that region, and the amount of agricultural products stored at storage facilities would be unevenly distributed among districts. Since the money is characterized by the fact that it can be converted to agricultural products of the indicated face value of the money if the holder of the money so desires, concentration of the outbound agricultural products to be converted from a conversion claimant or from the money convertible store in the area to the storage facility with a low volume of storage will cause a delay in the process. In such cases, the agricultural products should be transferred from another storage facility that stores the same type of agricultural products to replenish the agricultural products to be used for conversion. The time required for such a transfer should be within a time frame that does not violate expectations for conversion, which should be about one day. In the modern era of more efficient logistics and various means of transportation, agricultural products stored in a dispersed manner can be redistributed to eliminate deviations according to the demand in each district. Therefore, it is appropriate for the circulation of a single money and the store of a single agricultural product to be used to convert the money into a single unit of the country as a single region. However, geographically, it is difficult to resolve such deviations in a short period of time in countries composed of islands or separated by mountain ranges, etc. In such cases, it is desirable to issue the money and store the agricultural products used to convert the money in each region that can satisfy such deviations. If the same type of agricultural product can be produced across multiple countries on a continent, and if the transfer of the stored agricultural product can be implemented within an acceptable time frame, the money can be distributed across those multiple countries.

On the other hand, if it were to be implemented in a small district using a single money and its single agricultural product, the money would have the characteristics of community money, since it would target agricultural products produced in the district in which the money is circulated.

If the system is to be used as a traceability system for agricultural products, it is better to operate the system of the present invention with a specific money fixing a specific agricultural product rather than integrated management.

### Example 3

The following is an example of the invention of money, which is issued money that is convertible to agricultural products stored in storage equipment.

At the storage facility, the inventory of agricultural products will be monitored, weighed, and measured to meet certain quality requirements, and the quantity of the conforming quality agricultural products in stock will be determined. The quality and inventory quantity of agricultural products will be managed using computers, and the system operation organization will reflect the data and control the issuance and distribution of the money in conjunction with it.

If storage facilities are spread across multiple locations, the system operation organization will control the total amount of money issued and the total amount of agricultural products stored for converting the money by summing up the inventory data from each storage facility.

The system operation organization does not necessarily need to be manned, but can be configured to execute programs using computers by building a data center and providing the system with various data, parameters, and authentication codes. For this purpose, means of automation using AI (Artificial Intelligence) is also effective.

### Example 4

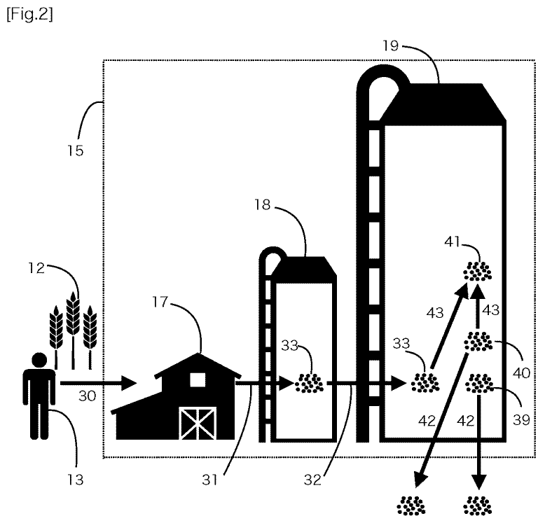

An example of how to reconcile the money of the invention with the storage of agricultural products used to convert the money is illustrated in FIG. 2.

When converting the money to agricultural products, the role of the money ends and ceases to exist, and the Agricultural products for conversion40 to be used for conversion are taken out of the Main storage equipment19 and shipping42 to the conversion claimant.

When the money is extinguished due to the life of the money, the Agricultural products for conversion40 for that amount of conversion are shipping42 from the main storage equipment19.

The Agricultural products for conversion40 into a transaction before the money has reached the end of its life shall be treated according to the assessment of the suitability of the quality of it. If a quantity of agricultural products equivalent to the volume of money transactions is available to ship42 from the Main storage equipment19, but the Agricultural products for conversion40 remain sufficiently fresh and continue to be compatible in quality, they shall be retained in the main storage equipment and set43 as Agricultural products for new conversion41. Agricultural products in a condition of freshness are generally agricultural products in the first year of production, new rice in the case of rice, and generally new grain in the case of grain. Conforming quality agricultural products can withstand storage with a certain level of quality for a certain period of time thereafter, and can continue to be stored as agricultural products for conversion repeatedly within the period of conformance of quality.

Agricultural products with reduced quality conformity39 has decreased due to loss of freshness or deterioration of quality over the course of stored in the main storage equipment are shipped42 on a first-in, first-out principle to maintain quality conformity.

Conversion the money, the life of the money, or the shipment of agricultural products whose quality conformity has declined will reduce the amount of agricultural products in the main storage equipment, which will need to be replenished. In addition, the issuance of the new money requires a corresponding increase in the amount of new agricultural products in the main storage equipment in order to be ready to convert the money.

In principle, newly produced, fresh products should be used as the agricultural products entering the storage facility. However, if it is difficult to receive new cargoes due to harvest failure or disasters, the shortage can be compensated by using moderately aged agricultural products or alternative products, or by making adjustments such as increasing the quantity of products to compensate for the lower quality when converting.

To make agricultural products convertible, when appropriating 1 unit of agricultural products for 1 unit of money, 100 units of money need not correspond individually to 100 units of agricultural products, but the total amount of 100 units of agricultural products for 100 units of money should be secured.

If the system is to be used for traceability purposes, since the particular money corresponds one-to-one to the particular agricultural product, the data and parameters of the money will be maintained even when the money is transacted, until it disappears due to its life or is converted to the agricultural product and consumed.

### Example 5

The following is an example of the depreciation of the money of the present invention.

The concept of the money is that if the agricultural product used to convert it is fixed and one continues to hold it consistently, the value of the money will also depreciate, since the agricultural product will deteriorate over time and its commodity value will decrease accordingly. In this case, there are several ways in which the money can be depreciated.

One of these is that over time, the money depreciates as the amount of the agricultural products that can be converted for a single unit of the money decreases. In order to keep the value of a unit of the money constant, the decrease in the amount of agricultural products used to convert the money should be filled with additional agricultural products, and for this purpose, the monetary system will request the cost of the additional agricultural products from the holder of the money. According to this, the holder of the money would have to pay an additional cost to maintain the value of the money, which would be the depreciation of the money according to the depreciation schedule of the money.

Or, it is the depreciation of the money as the amount of money owned by the holder of the money is reduced over time. In other words, the amount of money that was in the possession of the holder at the time of acquisition diminishes over time, resulting in a decrease in the real value of the money from the time of acquisition. To this end, the monetary system calculates the time elapsed since the date of acquisition of the money owned by the holder of the money, i.e., the time the money has been retired, and reduces the amount of money owned by the holder in accordance with the depreciation schedule of the money. According to this measure, holders of money would not have to bear any new costs of maintaining it against depreciation. However, the continued holding of the money will result in a decrease in the amount of money held, and this will cause the money to depreciate. It is as if the money in the holder's wallet were to decrease and disappear on its own with the passage of time.

The depreciation schedule should be set appropriately, taking into account the nature of the agricultural product used to convert the money and its consistency with the physical delivery common commodity requirements in the commodity futures market, etc. FIG. 3A through FIG. 3F show examples of how the depreciation schedule depreciates over time. When the depreciation progresses and the value of the money becomes zero, that is the expiration date and the life of the money. When money reaches the end of its life, it ceases to exist. FIG. 3A shows a linear depreciation starting from the date of issue or the date of acquisition, and FIG. 3B shows a linear depreciation after a certain period of grace from the starting date. FIG. 3C shows the case in which the value of the money does not depreciate from the starting date until the point in time when the life of the money is set, and the entire value is instantaneously reduced to zero; FIG. 3D shows the case in which the value of the money decreases in a nonlinear manner, depreciating in steps from the starting date to weekly, monthly, or yearly; and FIG. 3E shows the case in which the money depreciates according to a specific function. Furthermore, as shown in FIG. 3F, when the money reaches its set expiration date, it can be transferred to the new money at the equivalent value, or it can be transferred to the new money with a reduction44 in the value of the money as a renewal fee.

As an example, in FIG. 4, specific parameters are set to illustrate the money and monetary system of the present invention.

The example in FIG. 4 is the one shown in FIG. 3B, in which depreciation is deferred for a certain period of time from the starting date, and then depreciates linearly. The depreciation timing is the point in time when depreciation begins. There is a grace period45 from the starting date to the depreciation timing, followed by a depreciation period46 and finally, the value of the money becomes zero and the money ceases to exist.

Suppose that the grace period from the starting date to the depreciation timing of the money is 365 days, and the depreciation rate during the depreciation period is set at 0.1% per day. If the money is stored as it is, based on these parameters, the money will depreciate from the point when 365 days, the grace period45 from the starting date to the depreciation timing, elapses, and when 1,000 days, the depreciation period46 from the depreciation timing, elapses, the money will reach 100% depreciation and its value will be lost, and the money will have a life span.

However, if, for example, the convertible object of the money is rice, the actual rice, even after the date of the life of the money, i.e., 365 days until the timing of the depreciation of the money plus 1,000 days of the depreciation period between the start of the depreciation and the life of the money, i.e., a total of 1,365 days, the actual value of the rice will not be zero according to appropriate preservation measures.

If the holder of the money retires the money to the life of the money, without using it for transactions or converting it, the money will cease to exist at the end of its life, but the agricultural products that were prepared for the conversion to the money. will usually have a residual value, depending on the parameters set for the life of the money. This is because even if agricultural products lose their value as food, they still have demand and value as animal feed or as raw materials for industrial use. When the money disappears, the excess of the value of the physical commodity becomes the interest margin of the money-issuing organization. The interest margin will be used to pay for the construction and operation of the system, to finance the common goods of agricultural cooperative and agricultural producers group, to invest in infrastructure development, and to support agricultural producers. In addition, if the money is issued based on the national stockpile of agricultural products, it can be used to reduce stockpiling costs, to cover the cost of receiving new stockpiles of agricultural products, to repurchase the money in case of emergency, as hedging costs, insurance premiums, etc., thereby reducing the financial burden.

The concept of the money forming from the phenomenon of agricultural products deteriorating over time depreciates the money convertible to it, but does not require that the measured value of the deterioration of stored agricultural products over time match the depreciation rate of the money, except when the invention is used for traceability purposes. For example, if the general conforming quality period for an agricultural product is three years, it is not necessary to set the depreciation schedule of the money to match the measured actual degree of deterioration of the agricultural product, nor is it necessary to set the life of the money to be converted to it to be only nominal, three years. The deterioration of agricultural products should be viewed only as an incentive for the life or depreciation of money, and the life or depreciation schedule of money should be set according to the convenience of money circulation. In addition, the system also manages to match the total amount of the money issued against the total amount of produce stored. Therefore, the retiring period of individual money and the storage period of individual produce do not match. Because the storage and inventory management of the agricultural products ensures that agricultural products held for conversion are renewed and stored at high conforming quality on a first-in, first-out basis whenever possible, the agricultural products held for conversion of individual money issues have sufficient residual value at any point in the depreciation schedule of the money.

### Example 6

The following is an example of the point in time at which the money begins to depreciate and the starting date of the life of the money.

Since the money can have a life span as the time of use, the value of the money will decrease according to a depreciation schedule that defines how the value of the money will decrease until the end of its life. The life of the money is the elapse of a predetermined period of time starting from the date of issue or acquisition of the money. The depreciation schedule defines how the value of the money is to be reduced over its life. It can be set up so that the depreciation begins immediately from the starting date, or it can be set up so that the depreciation is left in place for a certain period of time, a grace period is set up, and the point at which the depreciation begins is set as the depreciation timing, and the value of the money decreases from that depreciation timing.

If the money is used in a transaction before it reaches the end of its life, the each date of acquisition of the money should be set as the starting date. The reason for doing so is that if the starting date of the money is fixed as the issue date of the money and the timing of depreciation and the life of the money are set, if the payer of the money retires the money for almost a year and the recipient acquires the money, the grace period for the timing of depreciation and the life of the money will be short and the money will depreciate prematurely and its life will be exhausted early, resulting in inequity.

Another means of eliminating the inequity caused by the timing of the depreciation of the money and the starting date of the life of the money is to collect and cancel the payer's payment money for each transaction and issue equivalent new money to be given to the recipient, so that the date of acquisition of the money matches the date of its issuance, which should be set as the starting date.

### Example 7

The following is an example of a data structure of the money of this invention.

The money is an electronic money, issued, circulated, and transacted by computer and network. As such, what constitutes the money is a block of data or a program. If the program is a block that contains a program, the money can be used as a smart contract to automatically execute, for example, a depreciation schedule for the money or a retirement process due to the life of the money.

The data block can include the unique issue number of the money, the date of issue and acquisition of the money, the type, variety and standard of the agricultural products used to convert, the transaction history of the money, and the amount and rate of transaction fees and taxes. If the money is to be a depreciating money, the monetary data should be composed by setting parameters related to the timing and schedule of depreciation, such as the grace period from the date of origination of the money until it begins to depreciate, the interval of depreciation, and the amount and rate of depreciation.

Furthermore, if the money is issued as a pair for a specific agricultural product and the purpose is to traceability of the agricultural products, the data should include information on the producer of the product, the location of production, the pesticides and fertilizers used, growth information, harvest date, and the means of processing.

These various types of data may be configured as data blocks on the individual money, or the unique issue number may be written on the individual money, the necessary data and parameters are centrally managed at the data center of the system operation organization, and based on the unique issue number of the money, the money data is communicated via the network each time it is used, and the system may be configured to communicate with the data center for inquiry, verification, and updating.

The structure of the money and the monetary system is to be implemented by computer and network, and data processing assumes that the system is connected to the network. However, it is assumed that the system will be offline due to communication conditions or disasters, and even in such a case, it is desirable that the money system should, at a minimum, still be operational. For this purpose, the data block of the each individual money should contain the necessary data and parameters so that transactions, balance checks, etc. can be performed offline at a practical level.

### Example 8

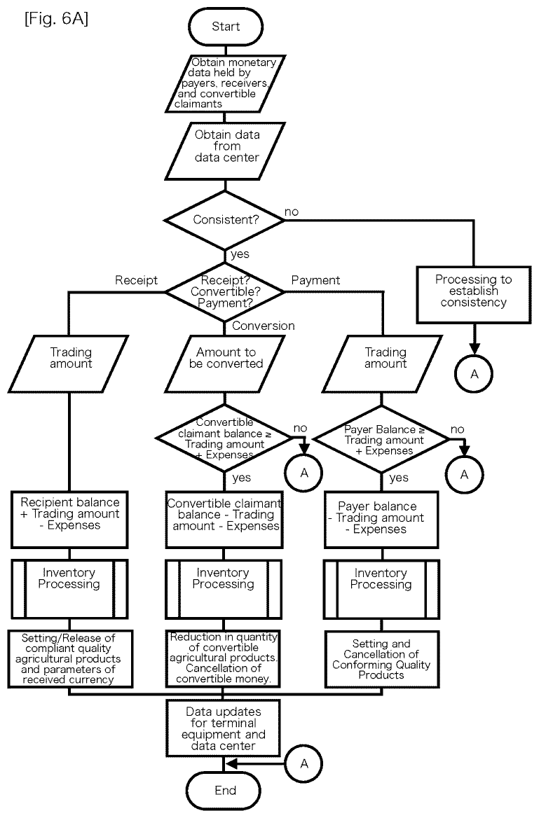

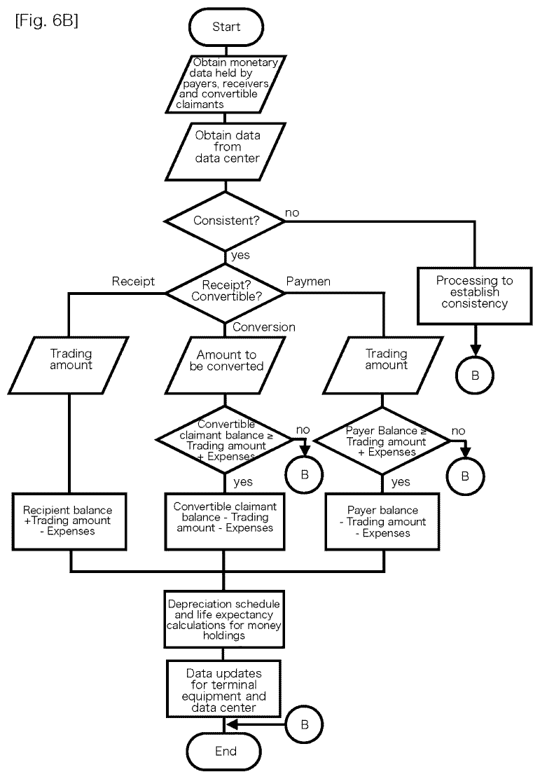

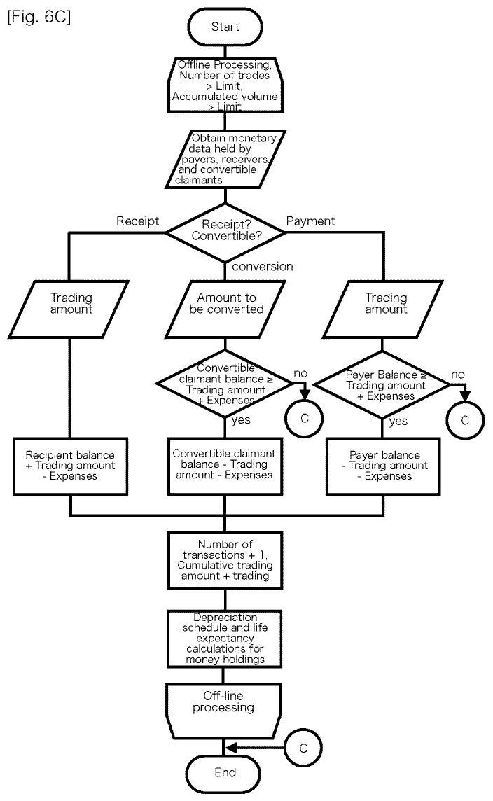

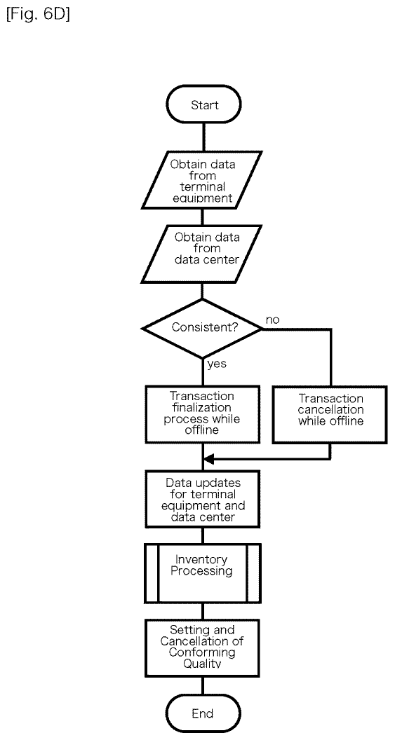

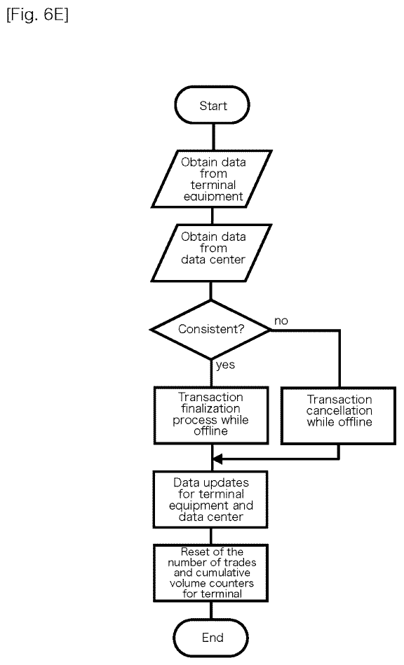

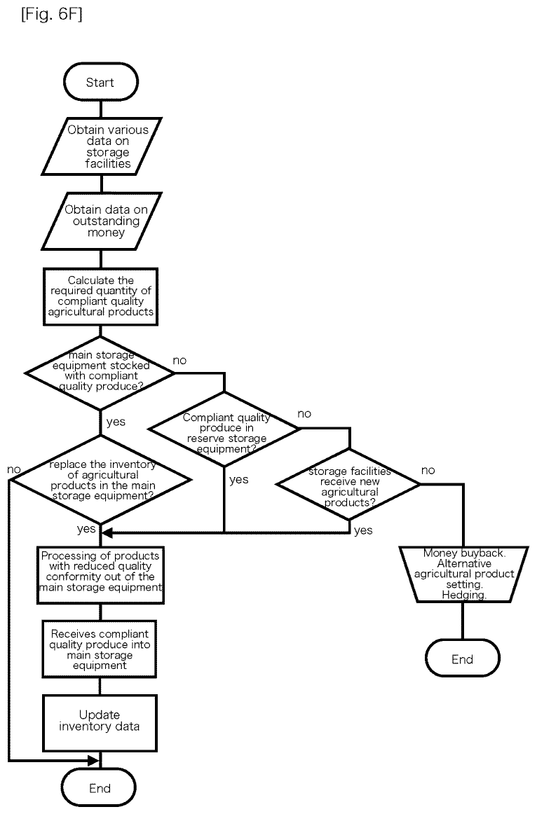

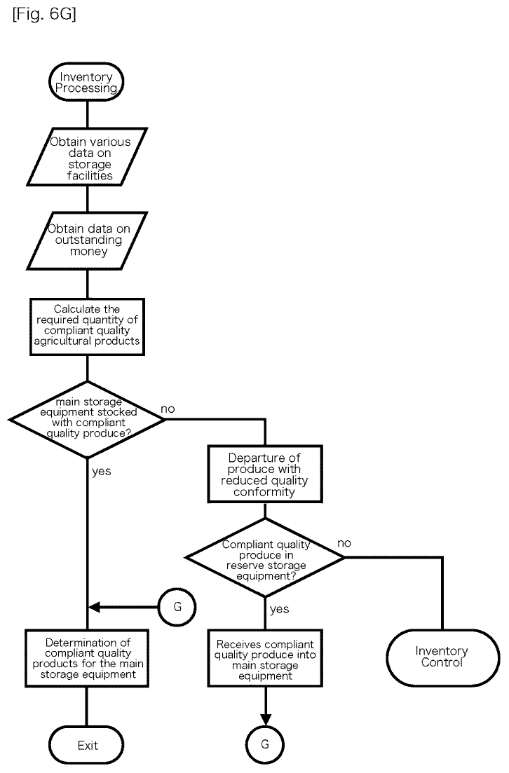

Examples of online and offline processing of the money are described in FIG. 5 and FIG. 6A through FIG. 6G.

When the terminal equipment of a trading participant and the data center of the system operation organization, which controls the entire system and processes data, are online, the system verifies data between the terminal equipment and the data center, and the data center also matches data based on the storage status of the agricultural products used to convert money with data based on the issuance and circulation status of the money to process transactions, settlements, and conversions. In the circulation and trading of the money, existing financial settlement systems, i.e., DTNS (Designed Time Net Settlement) and RTGS (Real-time Gross Settlement) settlement processes, can be implemented. The choice between DTNS and RTGS settlement processes will depend on the following factors: whether the money is to be settled in a single money market; whether there will be a financial intermediary or settlement intermediary; whether the money will be issued in multiple denominations and whether there will be settlement with other money or currencies; how long the settlement process will take to finalize; and whether the money will be settled in a single currency or in multiple denominations. The finalization of these settlement processes should be done within a certain amount of time. Considering these conditions and factors, the appropriate process should be used. If the financial settlement process is used, the data structure of the money should be in ISO 20022 format, which is an international standard. If blockchain technology is used in the system, it can be implemented through the transaction process realized in crypto asset transactions such as Bitcoin or Ethereum. Since the money of the invention is also a substitute for the agricultural products used to convert it, it is possible to put the transactions of the agricultural products on the financial settlement process by these fintechs.

On the other hand, transactions between the terminal equipment of a trading participant and the system operation organization using the monetary system while offline will result in settlement exposure, since the means of verifying the authenticity of the money and its consistency with the balance held depends on the data inherent in the individual money. Therefore, while offline, transactions should not be executed in large amounts and should be executed only on an emergency basis between trading participants. For example, in the event of a disaster, the transfer of foodstuffs using the money of the invention, which is convertible to the agricultural products, can be effectively realized by transferring the money from one holder to another, so that the recipient of the money can convert the money to the agricultural products at any time. At that time, even in an offline environment due to communication outages caused by disasters, etc., the system desires to process as many transactions as possible to achieve its objectives. In such a situation, the system should be constructed to handle offline transactions limited to a limited amount of money and a limited number of transactions. When offline, the application of the terminal equipment of the trading participant in the money system will verify whether the transaction is within the permissible range, process the settlement, and when it comes back online, transmit the results of the offline processing to the system operation organization for reconciliation and updating of the data in the system.

The flow in FIG. 5 is used to explain an example of limiting offline transactions by the number of transactions and transaction volume.

In FIG. 5, the counter for the number of transactions while offline is N and the counter for the cumulative volume of transactions while offline is M. As parameters, the limit on the number of transactions is denoted by n, and the limit on the cumulative volume of transactions while offline is denoted by m. The volume of transactions with the counterparty in each transaction is denoted as p1, p2, p3, and so on. Within each block of the flow, the numerical contents of n and m are shown.

Here, as an example, suppose n is set to 10 and m is set to 100.

In this case, FIG. 5 shows how offline transactions are stopped when the number of transactions N is less than 10 and the cumulative transaction volume M exceeds 100, and when the cumulative transaction volume M is less than 100 and the number of transactions N exceeds 10. The transaction also includes the conversion of the money into the agricultural products. The conversion is the same as receiving the equivalent physical agricultural products as a result of payment as the money movement of the money holder, and as a monetary transaction, the conversion is the same as the payment processing procedure.

In the flow in FIG. 5, in the first part of the flow, when the terminal device is offline, the application of the terminal device counts the sum of the transaction volume while it is offline as M, while counting N for the number of transactions. If M exceeds m, subsequent transactions are stopped and suspended until the terminal equipment is online. The example in FIG. 5 shows how the sum up to the individual transaction volumes p1, p2, and p3 are within the limit value m, and then M exceeds the value of m, i.e., 100, in subsequent transactions, causing the transaction to stop when M>100. Money transactions may be received from or paid to counterparties; in counting M, it is preferable to limit the amount of the money transactions by the sum of the absolute values of the individual transaction volumes, rather than by offsetting the money receipts and payments, to avoid settlement exposure. The second part of the flow shows how M is within the limit of m and stops trading when N exceeds n. In the example in FIG. 5, n=10, so this is the case when N>10.

Thus, if M or N exceeds the limit, the next transaction is suspended until the terminal equipment is online.

When the terminal equipment returns to the online operation from the offline operation, the terminal equipment and the data center of the system operation organization mutually communicate and check the transaction results during the offline operation, verify the consistency and legitimacy of the transaction, update the data in the data center, and reset the M counter value and N counter value of the terminal equipment to prepare for the next offline transaction.

In the unlikely event of unauthorized transactions during offline operation, those transactions will be voided or subjected to a recovery process when the system returns to online operation. Loss of assets due to such cases can be minimized by limiting the amount and number of transactions allowed while offline and by setting conditions, and the maintenance and reliability of the entire system can be supported by insurance coverage for such cases and penalties for the persons concerned.

Next, the online and offline processing processes are explained in examples using the flowcharts in FIG. 6A through FIG. 6G.

FIG. 6A and FIG. 6B are flowcharts of various processes in the monetary system when the terminal equipment of a trading participant and the data center of the system operation organization are online. The processing items are the transactions of the money by receipt, payment, and conversion, and the related processing of agricultural products to be used for conversion. Payment is the settlement of purchases of goods, remittances to others, etc. Receipt also occurs when a producer receives money when receiving agricultural products at a storage facility, when receiving money from others, or when exchanging money from other currencies. In those processes, network communication between the terminal equipment and the data center is used to reconcile mutual data, establish consistency, and execute the transaction. Depending on the transaction item, the system determines whether the transaction meets the conditions for execution when the money holder pays with the money, converts the money to the agricultural products, or receives the money from another party, and increases or decreases the transaction participant's money balance accordingly. In the example shown here, the system also subtracts fees and taxes related to the transaction from the balance as various expenses.

FIG. 6c is a flowchart of the program at the terminal equipment when the terminal equipment of the trading participant and the data center of the system operation organization are offline. The treatment in this state assumes transactions that take settlement exposure into account, as described above, and the flowchart introduces the flow in FIG. 5.

FIG. 6D and FIG. 6E show the flowcharts at the terminal equipment of the trading participants when they come back online after trading in the offline state described in FIG. 5 and FIG. 6C, and FIG. 6E shows the flowcharts at the data center of the system operation organization. In particular, transactions while offline cannot be reconciled with the data in the data center, so it is necessary to set up a recovery process in case an unauthorized transaction occurs during that time.

FIG. 6F is a flowchart of the program that manages the inventory of the agricultural products used for the conversion of the money. The method of managing the inventory is as described in Examples 2 through 4.

FIG. 6G is a flowchart of the inventory processing subroutine in the flowcharts of FIG. 6A and FIG. 6D. The inventory processing mechanism is as described in Examples 2 through 4.

The actions described in each block of these FIG. 6A through FIG. 6G flowcharts are as described herein. In the implementation of these programs, actions such as data acquisition and entry and physical movement may be performed artificially, or they may be performed inhumanly through automatically executed programmed transactions or automated warehouse systems. If a trading participant owns multiple terminal devices, whether they are managed individually or collectively depends on the specifications of the system and the application.

### Example 9

The following is an example of a case in which a holder of the money conducts a transaction with another person or settles with the money for the purchase of general consumer goods, etc.

In order to complete individual transactions, it is desirable to finalize those transactions in a short period of time, and to ensure the integrity of them, the RTGS method, which processes settlements in real time for each individual transaction, is preferable. In addition, for large transactions that do not require immediate trading, inter-dealer transactions, maintenance of pegging, clearing of cross-border transactions, unwinding of open positions, or clearing of financial instruments, for example, the DTNS method, where settlement is made at a specific time on a particular day, reduces the system load compared to the RTGS method.

It is desirable to use the standard time of the country that issues the money as the time stamp for the monetary system, but Greenwich Mean Time should be used when the money is circulated over a wide area or when the money is used for international transactions.

### Example 10

The following is an example of constructing a token and token system that is convertible to agricultural products by replacing the expression “money” with the expression “token” in the money and monetary system of the invention.

In the present invention, tokens are interpreted as part of the money, so the structure and mechanism of the tokens and the token system follows that of the money. Since tokens are, in particular, a term and mechanism used in the field of crypto assets, the affinity of the money of the invention will be enhanced by adopting the data structures, formats, and processes used in that field. Thereby, the money of the invention can be operated in the existing system of crypto asset transactions. This is due, for example, to the introduction of blockchain technology into the circulation and transaction process of the money. If the invention is to be constructed as a token and token system, it will have affinity with crypto assets and their systems. This means that if a crypto asset has no or little credibility of its own, the token of the invention can be used to collateralize that crypto asset or guarantee its convertibility. This is because the token of the invention is convertible to agricultural products, which indirectly collateralizes the crypto asset with the agricultural products, thus complementing the trustworthiness of the crypto asset. The invention can be a system that provides trust in crypto assets.

In operating the money and monetary system of the present invention, it may be difficult to operate in some countries due to conflicts with the laws of issuance and circulation concerning money and currency. In such cases, the system can be operated not as money, but as a token of a lower concept. Furthermore, when the system is operated as a traceability system for agricultural products and managed and operated as a substitute for such products, it can be implemented by limiting the role of the system from that of money to that of tokens.

### Example 11

The following is an example of the deployment of the money and money system in a virtual space.

In real-space society, agricultural operations produce agricultural products with substance, which are stored and then issued and circulated as the money of the present invention. The money is not an object with substance, such as paper money or coins, but consists of blocks of electronic data or programs, which are also the actual thing itself, backed by the agricultural product.

On the other hand, a society in a virtual space is a virtual space created by a computer, where one constructs a society that is not real, and one virtually locates oneself in that world and engages in activities there. Examples include role-playing games and simulation games. There is also a metaverse in which people place their avatars, which are their virtual alter egos, in a virtual three-dimensional space, and engage in activities in the society they have formed there. In such virtual spaces, virtual money, currency, game scores, etc., which are accepted within the application to which the player belongs, are given according to the activities in the space, and are used as a resource for activities in the space. These are used to purchase and trade items as virtual money or currency limited to that virtual space or application.

Both the money of the present invention and the money in virtual space, as electronic money, have a common or similar role and structure. This means that the money has the potential to be used across real and virtual space.

For example, a mechanism that allows the exchange of money in the virtual society and money in the real society by some means can provide a mechanism whereby virtual money obtained in the virtual society can be converted into money or other valuables through the money in the real society.

### INDUSTRIAL APPLICABILITY

This invention is inspired by the kuramai-kitte of the Dojima Rice Exchange in Japan and its trading mechanism, which is a very important origin in the history of commodity futures trading, and provides a means to widely use them in modern monetary transactions by means of a computer and network-based system.

This means can be used to issue and circulate local currencies such as community money. The aforementioned WIR BANK in Switzerland issues WIR as a local currency, and its liquidity is enhanced by depreciating its value at regular intervals. The depreciation of the money of the present invention results in the same effect as the depreciating money proposed by Gesell and others, but the invention was created by the pursuit of convenience in the distribution and management of agricultural products through the monetization of agricultural products and the inducement of depreciation of agricultural products over time, while Gesell's invention was created by pursuing the state of money in a market economy.

The system of rice trading at the Dojima Rice Exchange formed the basis of today's global commodity futures trading. The money and money system of the present invention will create a trading system and a new means of settlement that was not possible at the time due to the development of information processing technology, network environment, globalization, and fintech, which did not exist in the socioeconomic environment of the time. Furthermore, the monetary system of the present invention not only pursues the convenience of settlement, but also contributes to the increase of profits and the stability of livelihood of agricultural producers or organizations of producers by implementing the system of the present invention and the various transactions derived therefrom. The system also provides opportunities to create new financial instruments and economic activities through the use of derivatives.

The money of the present invention can be said to be a substitute for commodities and a substitute for currency. Therefore, it facilitates the linkage of settlement in the commodity market and settlement in the financial market, and contributes to the activation of the trading market and diversification of settlement by integrating commodity and financial transactions, and by utilizing financial methods such as hedging and derivatives, and financial derivatives. If the money of the present invention is used as a substitute for physical delivery in physical clearing in commodity futures trading, the cost of inspecting and maintaining agricultural products to be offered for physical clearing can be reduced, and participation in the commodity futures trading market can be facilitated. In addition, when diversifying assets and investing in a wide variety of agricultural products, the use of the money of the present invention issued for each type of the agricultural products can be easily developed for these applications.

The invention provides a price-based, creditworthy monetary system by issuing the money convertible to the agricultural products, which can be circulated and used for the payment of goods and services. It also functions as a means of traceability of the agricultural products by recording and managing data subdivided by type, variety, quality, production area, producer, or date of production in the data blocks that comprise the money of the present invention.

### REFERENCE SIGNS LIST

Reference numbers in each drawing indicate the following components/situations.
11 Money of the present invention
12 Agricultural products
13 Agricultural product producer(s)
14 Agricultural cooperative, Agricultural producers group
15 Storage facility
16 Storage facilities group
17 Agricultural products collection center
18 Preliminary storage equipment
19 Main storage equipment
20 System operation organization
21 Audit organization
22 Communication network
23 Money exchange store, Money convertible store
24 Commodity market, Commodity futures trading market
25 Financial market, Financial futures market
26 Crypto asset exchanges, Crypto asset market
27 Government agency
28 Financial institution
29 Trading participant
30 Receiving
31 Storage of agricultural products in storage equipment after drying and other preservation processes and inspection
32 Transfer of agricultural products between the preliminary storage equipment and the main storage equipment
33 Conforming quality agricultural products
34 Transfer of agricultural products between storage facilities
35 Storage data
36 Audit
37 Money data
38 Conversion
39 Agricultural products with reduced quality conformity
40 Agricultural products for conversion
41 Agricultural products for new conversion
42 Agricultural products shipping
43 Setting of agricultural products for conversion
44 Decrease in money value
45 Grace period until depreciation timing
46 Depreciation period

### CITATION LIST

The following publications were referenced for the invention.

### PATENT LITERATURE

1: JP 2004/86486 A2, “Settlement Method, Currency Data Storage Device, Electronic Money”, Mar. 18, 2004, Sony Corporation
2: JP 6491372 B2, “Payment Processing System, Payment Processing Method and Payment Processing Program”, Mar. 27, 2019, Mizuho Bank, Ltd.
3: JP 2021/167992 A2, “Automatic Rice Milling Facility,” Oct. 21, 2021, Kubota Corporation
4: JP H10/73374 A2, “Grain Dryer Control Method,” Mar. 17, 1998, SATAKE Precision Technology Co., Ltd

### Non Patent Literature

1: Satoshi Nakamoto, “Bitcoin: A Peer-to-Peer Electronic Cash System,” Nov. 1, 2008, https://bitcoin.org/bitcoin.pdf
2: Tokuichi Shimamoto, “A Basic Study of Kuramai-kitte”, 1960, Sangyo Keizai-sha, pp. 6-8, pp. 25-27
3: Yasuo Takatsuki, “Transmission of Market Information in Early Modern Japan”, March 2011, Journal of Postal Museum, No. 2, pp. 91-108
4: Yasuo Takatsuki, “Interlocking and Integration of the Direct Market in the Early Modern Period,” Sep. 25, 2009, Japan Society for Socio-Economic History, Socio-Economic History Society, Vol. 75 No. 3 pp. 291-311
5: Hidetaka Yoneyama, “The Potential of Community Money as a Means of Overcoming Deflation,” August 2003, Fujitsu Research Institute of Economics, Research Report No. 174, Fujitsu Research Institute of Economics.
6: Masami Shigeta, “The Future of Community Currency”, Jun. 16, 2005, National Diet Library, Research and Information (484)
7: Makoto Ito, “Silvio Gesell's Theory of Socialism and the Idea of Local Currency,” Jan. 20, 2015, Society for Economic Theory, Quarterly Journal of Economic Theory Vol. 51 No. 4
8: Shinjiro Takefu, “Storage of Grains”, Oct. 20, 1975, The Chemical Society of Japan, Chemical Education Vol. 23, No. 5
9: Tetsuo Oe, “Supply, Demand and Pricing Mechanism of U.S. Corn”, 2010, Japan External Trade Organization (JETRO) Institute of Developing Economies, Center for Regional Studies, Research Report “Food Crisis and Demand and Supply of Corn in Developing Countries”, Chapter 2.
10: Yukio Hiromasa and Masahiko Takashima, “The Problem of Cost Burden of Agricultural Common Property”, February 1984, Hokkaido University Agricultural Economics Review, Vol. 40 pp. 1-18

What is claimed is:

1. An electronic money convertible to agricultural products, according to specifies a quantity of the agricultural products to be converted by one unit of the money, the conforming quality and the quantity of a storage of the agricultural products are controlled by computer, issue the money in quantities commensurate with the conversion of the agricultural products of conforming quality based on the quantity of the agricultural product in storage, and the money convertible to agricultural products and its monetary system that the money is circulated by a network for use in transactions, and a consistency of the quantity of the agricultural products stored with the quantity of money is controlled by computer.

2. An electronic money convertible to agricultural products that a money is circulated by a network for use in transactions, according to specifies a quantity of the agricultural products to be converted by one unit of the money, storage of the agricultural products of conformable quality in quantities commensurate with the conversion of the quantity of the money, based on the quantity of the money issued, and the conforming quality and the quantity of the storage of the agricultural products are controlled by computer, and the money convertible to agricultural products and its monetary system, and a consistency of the quantity of the agricultural products stored with the quantity of money is controlled by computer.

3. The money according to claim 1 and/or claim 2, wherein the agricultural products have, for a certain period of time, the conforming quality required to qualify as food, feed, or industrial raw materials.

4. (canceled)

5. (canceled)

6. (canceled)

7. (canceled)

8. (canceled)

9. The money according to claim 1 and/or claim 2, wherein the money has an expiration date.

10. The money according to claim 9, wherein at the expiration date of the money, the money becomes worthless.

11. The money according to claim 9, wherein at the expiration date of the money, the money is renewed with a new money equal to a face amount of the money.

12. (canceled)

13. (canceled)

14. The money according to claim 1 and/or claim 2, wherein the money depreciates as the holder's quantity of the agricultural products to be converted by one unit of the money decreases over time.

15. The money according to claim 1 and/or claim 2, wherein the money depreciates as an amount of money held by the holder of the money decreases over time.

16. The monetary system according to claim 1 and/or claim 2, wherein the holder of the money has a right to demand from the issuer of the money the conversion of the money to the agricultural products, according to specifies a quantity of the agricultural products to be converted by one unit of the money, and the issuer of the money is obligated to convert the money to the agricultural products.

17. (canceled)

18. (canceled)

19. (canceled)

20. (canceled)

21. (canceled)

22. (canceled)

23. (canceled)

24. The money and its monetary system according to claim 1 and/or claim 2, wherein the money is used as token.

25. The token according to claim 24, wherein the token is used as collateral for other money or other token or crypto assets.
